(19) United States
(12) Patent Application Publication
(10) Pub. No.: US 2025/0329885 A1
(43) Pub. Date: Oct. 23, 2025

(54) BUSBAR UNIT AND CONNECTION MODULE

(71) Applicant: SUMITOMO WIRING SYSTEMS, LTD., Mie (JP)

(72) Inventors: Hiroyuki MATSUOKA, Mie (JP); Eiji TSUGUI, Mie (JP)

(21) Appl. No.: 18/870,399

(22) PCT Filed: May 10, 2023
(86) PCT No.: PCT/JP2023/017545

§ 371 Date: Nov. 28, 2024

(30) Foreign Application Priority Data
May 31, 2022 (JP) 2022-088215

(51) Int. Cl. H01M 50/503; H01M 50/209; H01M 50/517; H01R 4/34

(52) U.S. Cl. CPC H01M 50/503; H01M 50/209; H01M 50/517; H01R 4/34

(57) ABSTRACT

A busbar unit includes a busbar including a bolt fastening portion and a connector terminal portion, and a molded resin portion for covering the busbar. The molded resin portion includes a connector housing portion for covering the connector terminal portion, an intermediate covering portion for covering an intermediate portion of the busbar extending out from the connector housing portion, a first coupling portion coupling a part of the intermediate covering portion distant from the connector housing portion and the connector housing portion and a second coupling portion coupling a part of the intermediate covering portion closer to the connector housing portion than an intersecting part with the first coupling portion and an intermediate part of the first coupling portion.

### TECHNICAL FIELD

The present disclosure relates to a busbar unit and a connection module.

### BACKGROUND

Patent Document 1 discloses an inter-terminal connection structure for electrically connecting a plurality of devices via an energizing member. A combination of the plurality of devices is, for example, two unit cells or a unit cell and a junction block.

### PRIOR ART DOCUMENT

### Patent Document

Patent Document 1: International Publication No. WO 2020/241412

### SUMMARY OF THE INVENTION

### Problems to be Solved

The energizing member and the device may be detached and attached such as for the maintenance, inspection or exchange of the device. Out of such detaching and attaching operations, the attaching operation of the energizing member and the device includes an operation of connecting the energizing member and the device, and the detaching operation of the energizing member and the device includes an operation of disconnecting the energizing member and the device. If both ends of the energizing member are bolted in the inter-terminal connection structure of patent literature 1, each of bolts on the both ends possibly needs to be operated during the detaching and attaching operations of the energizing member and the device. Thus, improvement in work efficiency relating to the attachment and detachment of the energizing member and the device is required.

Accordingly, it is aimed to improve work efficiency relating to the attachment and detachment of an energizing member and a device.

### Means to Solve the Problem

The present disclosure is directed to a busbar unit to be electrically connected to a terminal of a battery pack, the busbar unit being provided with a busbar including a bolt fastening portion provided on one end to be electrically connected to the terminal of the battery pack by being bolted to the terminal and a connector terminal portion provided on the other end to be electrically connected to a connector terminal of a mating connector, and a molded resin portion for covering the busbar, the bolt fastening portion and the connector terminal portion of the busbar being provided apart from each other in each of a first direction and a second direction, the first direction being a normal direction to a side surface of the battery pack, the second direction being along the side surface of the battery pack, the molded resin portion including a connector housing portion for covering the connector terminal portion, an intermediate covering portion for covering an intermediate portion of the busbar extending out from the connector housing portion, a first coupling portion coupling a part of the intermediate covering portion distant from the connector housing portion and the connector housing portion and a second coupling portion coupling a part of the intermediate covering portion closer to the connector housing portion than an intersecting part with the first coupling portion and an intermediate part of the first coupling portion, a fixing portion to be fixed to the battery pack separately from the bolt fastening portion being provided on a side of the molded resin portion closer to the bolt fastening portion than a center of gravity position of the busbar unit in the second direction, and the second coupling portion being provided with a rotation suppressing portion to be hooked to a receiving portion of the battery pack to suppress the busbar unit from being inclined toward the connector housing portion in a state where the bolt fastening portion is not fastened.

### Effect of the Invention

According to the present disclosure, work efficiency relating to the attachment and detachment of a busbar unit and a device is improved.

### BRIEF DESCRIPTION OF THE DRAWINGS

FIG. 1 is a perspective view showing a busbar unit according to one embodiment and a connection module provided with this.

FIG. 2 is a side view showing the busbar unit according to the embodiment and the connection module provided with this.

FIG. 3 is a perspective view showing the busbar unit.

FIG. 4 is a plan view showing the busbar unit.

FIG. 5 is a front view showing the busbar unit.

FIG. 6 is a side view showing the busbar unit.

FIG. 7 is a section along VII-VII of FIG. 4.

FIG. 8 is a diagram showing an inclined state of the busbar unit.

### DETAILED DESCRIPTION TO EXECUTE THE INVENTION

### Description of Embodiments of Present Disclosure

First, embodiments of the present disclosure are listed and described.

The busbar unit of the present disclosure is as follows.

(1) The busbar unit of the present disclosure is to be electrically connected to a terminal of a battery pack and provided with a busbar including a bolt fastening portion provided on one end to be electrically connected to the terminal of the battery pack by being bolted to the terminal and a connector terminal portion provided on the other end to be electrically connected to a connector terminal of a mating connector, and a molded resin portion for covering the busbar, the bolt fastening portion and the connector terminal portion of the busbar being provided apart from each other in each of a first direction and a second direction, the first direction being a normal direction to a side surface of the battery pack, the second direction being along the side surface of the battery pack, the molded resin portion including a connector housing portion for covering the connector terminal portion, an intermediate covering portion for covering an intermediate portion of the busbar extending out from the connector housing portion, a first coupling portion coupling a part of the intermediate covering portion distant from the connector housing portion and the connector housing portion and a second coupling portion coupling a part of the intermediate covering portion closer to the connector housing portion than an intersecting part with the first coupling portion and an intermediate part of the first coupling portion, a fixing portion to be fixed to the battery pack separately from the bolt fastening portion being provided on a side of the molded resin portion closer to the bolt fastening portion than a center of gravity position of the busbar unit in the second direction, and the second coupling portion being provided with a rotation suppressing portion to be hooked to a receiving portion of the battery pack to suppress the busbar unit from being inclined toward the connector housing portion in a state where the bolt fastening portion is not fastened.

According to the busbar unit of (1), since the other end of the busbar is connected to the mating connector in the busbar unit, work efficiency relating to the attachment and detachment of the busbar unit and a device is improved as compared to the case where the other end of the busbar is the bolt fastening portion. Further, by connecting the other end of the busbar to the connector, the other end of the busbar may not be possibly supported in the state where the bolt fastening portion on the one end of the busbar is not fastened. Even in this case, since the rotation suppressing portion of the second coupling portion is hooked to the receiving portion of the battery pack to suppress the busbar unit from being inclined toward the connector housing portion in the state where the bolt fastening portion on the one end of the busbar is not fastened, work efficiency relating to a bolt operation on the one end is improved.

(2) In the busbar unit of (1), the molded resin portion may be made of fiber reinforced plastic. In this way, even if the molded resin portion is made of fiber reinforced plastic, flow passages for the fiber reinforced plastic are increased during the molding of the molded resin portion and directions of fibers contained in the fiber reinforced plastic can be scattered by the presence of the first and second coupling portions.

(3) In the busbar unit of (1) or (2), the molded resin portion may include a cut extending between an end part of the intermediate covering portion on the one end side of the busbar and the fixing portion. In this way, stress applied to the busbar unit from the battery pack can be distributed during the expansion of the battery pack.

(4) In the busbar unit of any one of (1) to (3), the first coupling portion may be thicker than the second coupling portion. In this way, a weight increase of the molded resin portion can be suppressed since the second coupling portion is thinner than the first coupling portion while the molded resin portion is firmly reinforced by the first coupling portion.

(5) In the busbar unit of any one of (1) to (4), one first coupling portion and one second coupling portion may be provided. In this way, a weight increase of the molded resin portion can be suppressed.

(6) In the busbar unit of any one of (1) to (5), the busbar may be formed by one plate member from the bolt fastening portion to the connector terminal portion. In this way, the busbar including the bolt fastening portion and the connector terminal portion can be provided without welding or the like.

(7) Further, a connection module of the present disclosure is provided with a battery pack including a terminal, a mating connector including a connector terminal and a connector housing, and a busbar unit including a busbar for connecting the terminal and the connector terminal and a molded resin portion for covering the busbar, the busbar including a bolt fastening portion provided on one end to be fastened to the terminal by a bolt and a connector terminal portion provided on the other end to be connected to the connector terminal, the molded resin portion including a connector housing portion to be fit to the connector housing while covering the connector terminal portion, and an intermediate covering portion for covering an intermediate portion of the busbar extending out from the connector housing, a center of gravity of the busbar unit being closer to the connector housing portion than the bolt fastening portion, and a receiving portion of the battery pack and the molded resin portion contacting to suppress the busbar unit from being inclined toward the connector housing portion in a state where the bolt is not fastened after being passed through the bolt fastening portion.

According to the connection module of (7), since the other end of the busbar is connected to the mating connector in the busbar unit, work efficiency relating to the attachment and detachment of the busbar unit and a device is improved as compared to the case where the other end of the busbar is the bolt fastening portion. Further, by connecting the other end of the busbar to the connector, the other end of the busbar may not be possibly supported in the state where the bolt fastening portion on the one end of the busbar is not fastened. Even in this case, since the receiving portion of the battery pack and the molded resin portion contact to suppress the busbar unit from being inclined toward the connector housing portion in the state where the bolt is not fastened after being passed through the bolt fastening portion, work efficiency relating to a bolt operation is improved.

### DETAILS OF EMBODIMENT OF PRESENT DISCLOSURE

A specific example of a busbar unit of the present disclosure is described with reference to the drawings. Note that the present disclosure is not limited to these illustrations, but is represented by claims and intended to include all changes in the scope of claims and in the meaning and scope of equivalents.

### Embodiment

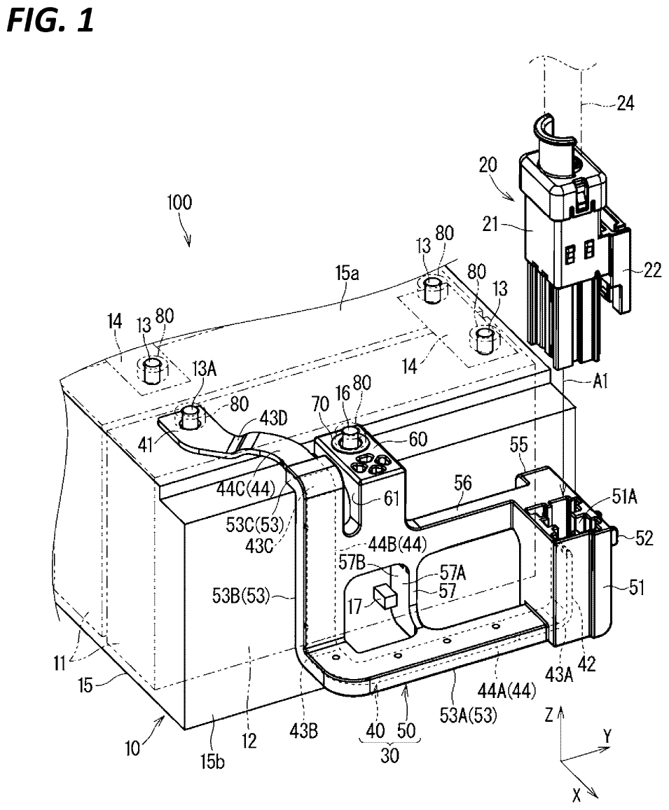

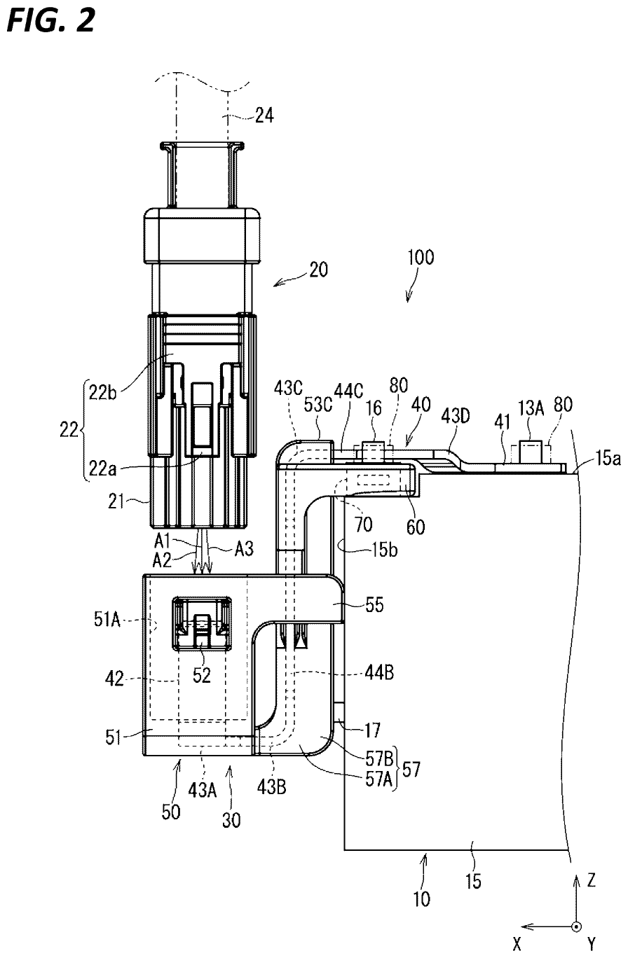

Hereinafter, a busbar unit according to one embodiment is described. FIG. 1 is a perspective view showing a busbar unit 30 according to the embodiment and a connection module 100 provided with this. FIG. 2 is a side view showing the busbar unit 30 according to the embodiment and the connection module 100 provided with this.

The busbar unit 30 is electrically connected to a terminal 13A of a battery pack 10. The busbar unit 30 is also electrically connected to a connector terminal 23 of a mating connector 20. The busbar unit 30 is interposed between the battery pack 10 and the mating connector 20 and electrically connects the terminal 13A of the battery pack 10 and the connector terminal 23 of the mating connector 20. In the present disclosure, a connected assembly of the battery pack 10, the mating connector 20 and the busbar unit 30 is assumed as the connection module 100. Note that a state where the busbar unit 30 and the mating connector 20 are disassembled without being connected is shown in FIGS. 1 and 2. The battery pack 10 and the mating connector 20 as connection partners of the busbar unit 30 are described first.

The battery pack 10 includes a plurality of cell batteries 11, connection conductors 14 and an enclosure 15. Each cell battery 11 includes a battery body 12 and a plurality of terminals 13. The battery body 12 is a part for storing electric charges. The plurality of terminals 13 are provided on the battery body 12 to connect the battery body 12 to an electrical device and include a positive terminal and a negative terminal. The plurality of cell batteries 11 are, for example, serially connected via the connection conductors 14. The connection conductor 14 connects the positive terminal and the negative terminal of the adjacent cell batteries 11. The terminals 13 and the connection conductors 14 may be of any form. Here, the terminal 13 is a stud bolt 13. The connection conductor 14 is a metal plate formed with holes, through which the stud bolts 13 are passed. The enclosure 15 holds the plurality of cell batteries 11. The plurality of cell batteries 11 are held in the enclosure 15 and integrated.

The terminal 13A of the battery pack 10 to be connected to the busbar unit 30 is located on an upper surface 15a of the battery pack 10. Here, the terminal 13A is the terminal 13A of the cell battery 11 located on an end part, out of the plurality of cell batteries 11 serially connected. Since the terminal 13 of the cell battery 11 is a stud bolt as described above, the terminal 13A of the battery pack 10 to be connected to the busbar unit 30 is a stud bolt here. Of course, a terminal of a battery pack to be connected to the busbar unit 30 may be a terminal provided separately from the terminals 13 of the cell battery 11 and electrically conductive with the terminals 13 of the cell battery 11. Further, a terminal of a battery pack to be connected to the busbar unit 30 may be a metal plate or the like formed with a hole, through which a bolt is passed.

A fixing bolt 16 is also provided on the upper surface 15a of the battery pack 10. The fixing bolt 16 projects in the same direction as the stud bolt 13A. The fixing bolt 16 is a bolt for fixing the busbar unit 30. The fixing bolt 16 does not electrically connect the cell battery 11 and a busbar 40 in the busbar unit 30. Here, on the upper surface 15a of the battery pack 10, a part where the fixing bolt 16 is provided is lower than a part where the stud bolt 13A is provided. Here, a step is formed between the part where the fixing bolt 16 is provided and the part where the stud bolt 13A is provided on the upper surface 15a of the battery pack 10.

As shown in FIG. 2, a receiving portion 17 is provided on a side surface 15b of the battery pack 10. Most of the busbar unit 30 except a part to be fastened to the stud bolt 13A and a part to be fastened to the fixing bolt 16 is located at a position facing the side surface 15b. The receiving portion 17 suppresses the rotation of the busbar unit 30 by contacting the busbar unit 30. The receiving portion 17 projects further outward than a part of the side surface 15b around the receiving portion 17.

Here, an X direction, a Y direction and a Z direction orthogonal to each other are shown in FIG. 1. The X direction is a normal direction to the side surface 15b where the receiving portion 17 is provided and an example of a first direction. The Y direction is a direction along the side surface 15b and an example of a second direction. Here, the Y direction is a direction orthogonal to a projecting direction of the stud bolt 13A, out of directions along the side surface 15b. The Z direction is a projecting direction of the stud bolt 13A and the fixing bolt 16. Also in FIG. 2 and subsequent figures, an X direction, a Y direction and a Z direction corresponding to those of FIG. 1 are shown.

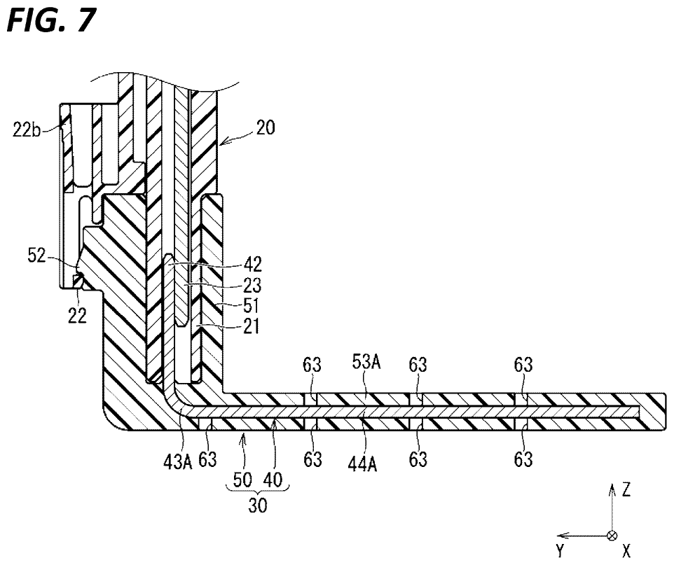

The mating connector 20 includes a connector housing 21 and the connector terminal 23 (see FIG. 7). For example, the connector housing 21 is made of insulating resin, and the connector terminal 23 is made of electrically conductive metal. The connector housing 21 holds the connector terminal 23. A lock receiving portion 22 is provided on a side surface of the connector housing 21. The lock receiving portion 22 is locked by a lock portion 52 provided on the busbar unit 30 when the mating connector 20 is connected to the busbar unit 30. Here, the lock receiving portion 22 includes a lock piece 22a to be locked to the lock portion 52 and an operating portion 22b for deforming the lock piece 22a away from the lock portion 52 at the time of unlocking. One end of the connector terminal 23 is connected to the busbar unit 30. One end of a wire 24 is connected to the other end of the connector terminal 23. The connector terminal 23 and the wire 24 are connected by crimping, insulation displacement, welding or the like.

The wire 24 is, for example, a coated wire including a conductor core wire and an insulation coating. The conductor core wire is, for example, a stranded wire formed by twisting a plurality of metal strands. The insulation coating covers the conductor core wire. The other end of the wire 24 is connected to an electrical device different from the battery pack 10. For example, a connection terminal, a connector or the like is provided on the other end of the wire 24 and connected to the other electrical device. Such an electrical device is not particularly limited and may be, for example, a battery pack configured similarly to the battery pack 10 and provided separately from the battery pack 10. Further, the electrical device may be, for example, a busbar unit configured similarly to the busbar unit 30 and provided on another battery pack. Further, the electrical device may be, for example, a junction box or the like.

The wire 24 is, for example, more easily bent as compared to the busbar 40 in the busbar unit 30. By interposing the wire 24 between the battery pack 10 and the other electrical device, a degree of freedom of a positional relationship of the battery pack 10 in a vehicle and the other electrical device is enhanced. Further, if there is a design change in the positional relationship of the battery pack 10 and the other electrical device, such a design change can be dealt with by bending the wire 24 without a design change of another member.

### <Busbar Unit>

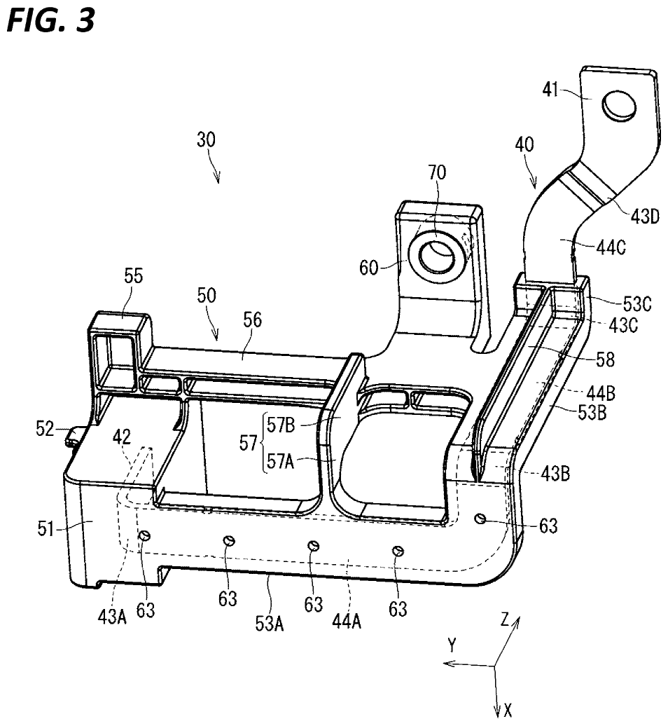

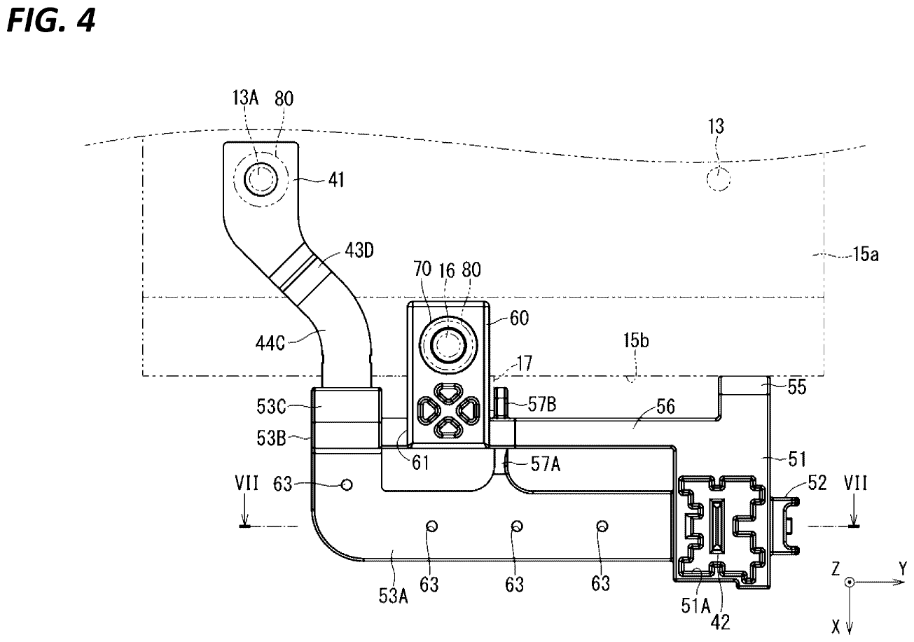

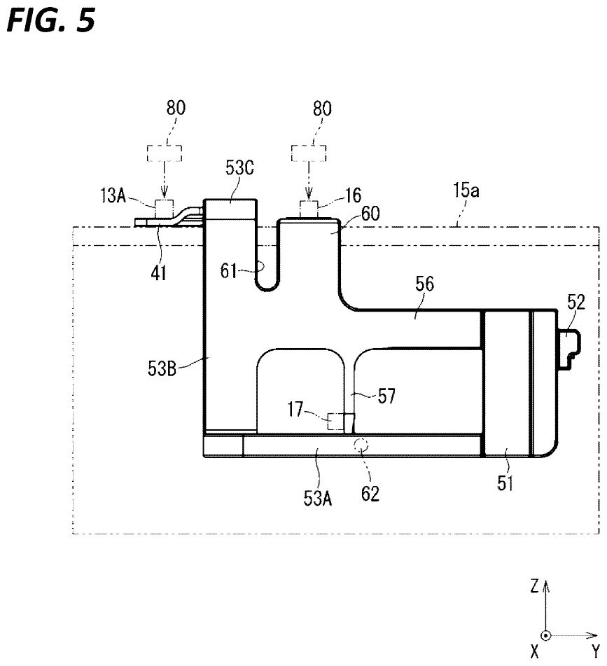

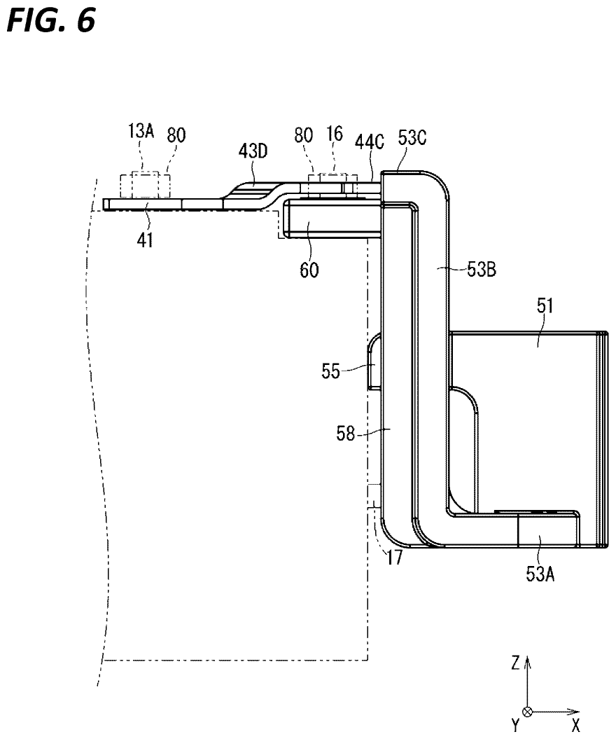

The busbar unit 30 is more specifically described further with reference to FIGS. 3 to 7. FIG. 3 is a perspective view showing the busbar unit 30. FIGS. 1 and 3 are perspective views viewed from mutually different viewpoints. FIG. 4 is a plan view showing the busbar unit 30. FIG. 5 is a front view showing the busbar unit 30. FIG. 6 is a side view showing the busbar unit 30. FIG. 6 shows a side surface on a side opposite to the one shown in FIG. 2. FIG. 7 is a section along VII-VII of FIG. 4. Note that the battery pack 10 is shown by a virtual line in FIGS. 4 to 6. Further, the mating connector 20 is shown by a solid line in FIG. 7.

The busbar unit 30 is provided with the busbar 40 and a molded resin portion 50. The molded resin portion 50 is formed by insert molding with the busbar 40 as an insert part. In this embodiment, the molded resin portion 50 includes a collar 70 as an insert part, besides the busbar 40. The collar 70 is a member for reinforcing a fixing portion 60 in the molded resin portion 50. The collar 70 may be press-fit into the molded resin portion 50 later. Further, the collar 70 may be omitted.

The busbar 40 includes a bolt fastening portion 41 and a connector terminal portion 42. The bolt fastening portion 41 is provided on one end of the busbar 40. The bolt fastening portion 41 is bolted and electrically connected to the terminal 13A of the battery pack 10. The connector terminal portion 42 is provided on the other end of the busbar 40. The connector terminal portion 42 is electrically connected to the connector terminal 23 of the mating connector 20. The bolt fastening portion 41 and the connector terminal portion 42 are provided apart from each other in each of the X direction and the Y direction.

The busbar 40 is formed by one plate member from the bolt fastening portion 41 to the connector terminal portion 42. Such a plate member is made of metal and in the form of an elongated plate continuous in an extension direction and having a flat cross-section with a thickness smaller than a width. The busbar 40 includes bent portions 43A, 43B, 43C and 43D formed by bending the plate member in a thickness direction. The bent portions 43A, 43B, 43C and 43D are provided in this order from the connector terminal portion 42 toward the bolt fastening portion 41. The plate member is bent by 90° in the thickness direction at the bent portions 43A, 43B and 43C. The plate member is bent to offset in the thickness direction at the bent portion 43D.

A part of the busbar 40 closer to the other end than the bent portion 43A serves as the connector terminal portion 42. The connector terminal portion 42 extends along the Z direction from the bent portion 43A. A part of the busbar 40 closer to the one end than the bent portion 43D serves as the bolt fastening portion 41. The bolt fastening portion 41 extends along the X direction from the bent portion 43D. A part of the busbar 40 between the bent portions 43A and 43D serves as an intermediate portion 44. Here, the intermediate portion 44 includes a first intermediate portion 44A, a second intermediate portion 44B and a third intermediate portion 44C.

A part of the busbar 40 between the bent portions 43A and 43B is the first intermediate portion 44A. The first intermediate portion 44A changes an extension direction to the X direction before the bent portion 43B and reaches the bent portion 43B after extending along the Y direction from the bent portion 43A. A part of the busbar 40 between the bent portions 43B and 43C is the second intermediate portion 44B. The second intermediate portion 44B extends in the Z direction from the bent portion 43B and reaches the bent portion 43C. A part of the busbar 40 between the bent portions 43C and 43D is the third intermediate portion 44C. The third intermediate portion 44C changes an extension direction to a direction intersecting each of the X direction and the Y direction in an XY plane before the bent portion 43D and reaches the bent portion 43D after extending along the X direction from the bent portion 43C.

Note that, in the busbar 40, the number, positions, bending directions and the like of the bent portions are not limited to those described above and can be set as appropriate.

The molded resin portion 50 includes a connector housing portion 51, an intermediate covering portion 53, a projection 55, a first coupling portion 56, a second coupling portion 57, the fixing portion 60, and a cut 61.

The connector housing portion 51 covers the connector terminal portion 42. The connector housing portion 51 is provided apart from the side surface 15b of the battery pack 10 in the X direction to face the side surface 15b. The bent portion 43A is located in the connector housing portion 51. The connector housing portion 51 is provided with a fitting recess 51A, into which the tip of the mating connector 20 is fit. The fitting recess 51A is a hole continuous in the Z direction. The fitting recess 51A is open in the upper surface of the connector housing portion 51. The tip of the connector terminal portion 42 projects into the fitting recess 51A from a bottom surface located on a side opposite to an opening of the fitting recess 51A. The busbar 40 extends outward from the connector housing portion 51 on the way to the bent portion 43B from the bent portion 43A. Here, the busbar 40 extends outward from the connector housing 51 near the bent portion 43A. The busbar 40 extends out from an end part of the connector housing portion 51 on a side opposite to an end part provided with the opening of the fitting recess 51A in the Z direction.

The intermediate covering portion 53 covers the intermediate portion 44 of the busbar 40 extending out from the connector housing portion 51. The intermediate covering portion 53 includes a first covering portion 53A, a second covering portion 53B and a third covering portion 53C. The first covering portion 53A extends from the connector housing portion 51. The second covering portion 53B extends in a direction (here, Z direction) intersecting an extension direction (here, Y direction) of a part of the first covering portion 53A extending out from the connector housing portion 51. The third covering portion 53C extends in a direction (here, X direction) intersecting the second covering portion 53B. Here, the first covering portion 53A covers a part located outside the connector housing portion 51, out of the first intermediate portion 44A of the busbar 40. The second covering portion 53B covers the second intermediate portion 44B of the busbar 40. The third covering portion 53C covers a part near the bent portion 43C, out of the third intermediate portion 44C of the busbar 40. A part coupling the first and second covering portions 53A, 53B covers the bent portion 43B, and a part coupling the second and third covering portions 53B, 53C covers the bent portion 43C. A part near the bent portion 43D, out of the third intermediate portion 44C of the busbar 40, and the bolt fastening portion 41 are not covered by the molded resin portion 50.

As shown in FIG. 2, the projection 55 projects in the X direction from the connector housing portion 51 toward the side surface 15b of the battery pack 10. The projection 55 contacts the side surface 15b of the battery pack 10 with the busbar unit 30 mounted on the battery pack 10. The projection 55 projects from an end part provided with the opening of the fitting recess 51A in the Z direction, out of the connector housing portion 51.

The first coupling portion 56 couples a part of the intermediate covering portion 53 separated from the connector housing portion 51 and the connector housing portion 51. Here, the first coupling portion 56 couples the second covering portion 53B and the connector housing portion 51. Here, one first coupling portion 56 is provided. The first coupling portion 56 linearly extends in parallel to the Y direction. The first coupling portion 56 extends from the end part provided with the opening of the fitting recess 51A in the Z direction, out of the connector housing portion 51. The first coupling portion 56 and the first covering portion 53A extend in parallel along the Y direction from the connector housing portion 51. A part of the first covering portion 53A extending out from the connector housing portion 51 along the Y direction is separated from the first coupling portion 56 in the X direction and the Z direction. The first coupling portion 56 is connected to the side surface 15B of the connector housing portion 51, from which the projection 55 projects. The tip of the first coupling portion 56 is also connected to the projection 55.

The second coupling portion 57 couples a part of the intermediate covering portion 53 closer to the connector housing portion 51 than an intersecting part with the first coupling portion 56 and an intermediate part of the first coupling portion 56. Here, the second coupling portion 57 couples the first covering portion 53A and the first coupling portion 56. Here, one second coupling portion 57 is provided. The second coupling portion 57 linearly extends in parallel to the Z direction. As shown well in FIG. 5, the second coupling portion 57 is located closer to the second covering portion 53B than a center between the connector housing portion 51 and the second covering portion 53B. In the Y direction, the fixing portion 60 is located between the second covering portion 53B and the second coupling portion 57.

Here, the second coupling portion 57 includes a coupling body 57A and a rib 57B. The coupling body 57A couples the first covering portion 53A and the first coupling portion 56. The rib 57 projects further toward the battery pack 10 than the coupling body 57A along the X direction. In the X direction, a projecting dimension of the rib 57B is smaller than that of the projection 55. As shown well in FIG. 3, the rib 57B projects further toward the battery pack 10 than the first coupling portion 56 along the X direction. The upper end of the rib 57B in the Z direction reaches the intermediate portion 44 of the first coupling portion 56.

The connector housing portion 51, the first covering portion 53A, the second covering portion 53B and the first coupling portion 56 are coupled to form a closed annular shape. An opening surrounded by the connector housing portion 51, the first covering portion 53A, the second covering portion 53B and the first coupling portion 56 is present in the molded resin portion 50. This opening is partitioned into two by the second coupling portion 57. An opening surrounded by the connector housing portion 51, the first covering portion 53A, the second coupling portion 57 and the first coupling portion 56 and an opening surrounded by the first covering portion 53A, the second covering portion 53B, the first coupling portion 56 and the second coupling portion 57 is present in the molded resin portion 50.

A thickness (dimension along the X direction) of the first coupling portion 56 is larger than a thickness (dimension along the Y direction) of the second coupling portion 57. The thickness (dimension along the X direction) of the first coupling portion 56 is equal to a thickness of the intermediate covering portion 53 (e.g. dimension of the first covering portion 53A along the Z direction). A width (dimension along the Z direction) of the first coupling portion 56 is smaller than a width of the intermediate covering portion 53 (e.g. dimension of the second covering portion 53B along the Y direction).

The fixing portion 60 is fixed to the battery pack 10, separately from the bolt fastening portion 41. The fixing portion 60 is provided closer to the bolt fastening portion 41 than a center of gravity position of the busbar unit 30 in the Y direction in the molded resin portion 50. In other words, the center of gravity position of the busbar unit 30 in the Y direction is located closer to the connector housing portion 51 than the fixing portion 60. The fixing portion 60 projects from the first coupling portion 56.

The molded resin portion 50 is provided with a rotation suppressing portion. Here, the rib 57B functions as the rotation suppressing portion. The rotation suppressing portion 57B is hooked to the receiving portion 17 provided on the side surface 15b of the battery pack 10. The rotation suppressing portion 57B suppresses the inclination of the busbar unit 30 toward the connector housing portion 51 in a state where the bolt fastening portion 41 is not fastened and the fixing portion 60 is not fixed. Here, the rotation suppressing portion 57B is provided on the second coupling portion 57. The rib 57B functions as the rotation suppressing portion 57B by being hooked to the receiving portion 17.

In this embodiment, a rib 58 parallel to the rib 57B is provided on the second covering portion 53B. The rib 58 projects further toward the battery pack 10 than the second covering portion 53B along the X direction. The upper end of the rib 58 in the Z direction reaches the lower surface of the third covering portion 53C. A dimension of the rib 58 in the Y direction is smaller than that of the second covering portion 53B in the Y direction. One rib 58 is provided in a center of the second covering portion 53B in the Y direction. A plurality of the ribs 58 may be provided. In the X direction, a projecting dimension of the rib 58 is smaller than that of the projection 55 and equal to that of the rib 57B. The ribs 57B, 58 do not reach the side surface 15b of the battery pack 10. Note that, when the battery pack 10 expands due to heat or the like, the side surface 15b of the battery pack 10 may possibly contact the ribs 57B, 58. Even in this case, the ribs 57B, 58 are hardly affected by the expansion of the battery pack 10 due to the heat or the like since being thin.

The cut 61 extends between the fixing portion 60 and an end part of the intermediate covering portion 53 on the side of the bolt fastening portion 41. Here, the third covering portion 53C and the fixing portion 60 are completely separated by the cut 61. Further, a part of the second covering portion 53B on the side of the third covering portion 53C and the fixing portion 60 are also completely separated by the cut 61. In the Z direction, the cut 61 reaches the upper surface of the first coupling portion 56. In the Z direction, the cut 61 does not reach the height of the upper surface of the connector housing portion 51. A width (dimension along the Z direction) of a part of the first coupling portion 56 coupled to the second covering portion 53B is larger than a width (dimension along the Z direction) of a part of the first coupling portion 56 coupled to the connector housing portion 51. A width (dimension along the Y direction) of the cut 61 is larger than a thickness (dimension along the Y direction) of the second coupling portion 57.

The molded resin portion 50 is made of fiber reinforced plastic (FRP). Fibers contained in the fiber reinforced plastic are not particularly limited, but are, for example, glass fibers. A resin serving as a base in the fiber reinforced plastic is not particularly limited, but is, for example, polybutylene terephthalate (PBT).

The molded resin portion 50 is molded by pouring a material (here, molten resin containing fibers) into a mold. A mark of a gate for pouring the material into the mold remains on the molded resin portion 50. In an example shown in FIG. 5, such a gate mark 62 is provided on the first covering portion 53A. In the example shown in FIG. 5, the gate mark 62 is provided on a surface of the first covering portion 53A on a side opposite to a surface coupled to the second coupling portion 57. Of course, the position of the gate mark 62 is not limited to this and can be set as appropriate.

The fibers flow in the mold together with the molten resin, and the flow of the fibers stops when the flow of the molten resin stops. By curing the molten resin, the orientations of the fibers are fixed. Accordingly, the fibers contained in the fiber reinforced plastic normally extend in a flowing direction of the molten resin in the molded resin portion 50. In this embodiment, parts, which will become the first and second coupling portions 56, 57, also serve as flow passages for the molten resin, besides a part, which will become the intermediate covering portion 53. Thus, the flow passages can be branched, whereby the orientations of the fibers are hardly aligned in a certain direction. In this way, it is suppressed that the molded resin portion 50 made of fiber reinforced plastic is easily cracked in a specific direction. Such a specific direction of a crack is, for example, a direction along an extension direction of the fibers.

Further, since the molten resin containing the fibers is normally harder to flow than a molten resin containing no fibers, the molten resin containing the fibers hardly spreads in the mold. Since the second coupling portion 57 is present near the gate mark 62 in this embodiment, a flow passage corresponding to the second coupling portion 57 is present as a material flow passage immediately after the entry into the mold through the gate, besides a flow passage corresponding to the first covering portion 53A. Thus, the material easily spreads in the mold.

The mold for molding the molded resin portion 50 includes an upper mold and a lower mold. Here, the upper and lower molds are vertically removed in the Z direction. The molded resin portion 50 is formed into a shape free from parts (parts becoming so-called undercuts) facing each other across a space in the Z direction. For example, the first covering portion 53 A and the first coupling portion 56 are suppressed from becoming undercuts by being provided apart from each other in the X direction. Further, the rib 57B of the second coupling portion 57 and the fixing portion 60 are suppressed from becoming undercuts by being provided apart from each other in the Y direction.

During the molding of the molded resin portion 50, the insert parts (here, the busbar 40 and the collar 70) are held between the upper and lower molds. Furter, the first intermediate portion 44A of the busbar 40 is held by positioning pins here. Positioning pin recesses 63, which will become marks of the positioning pins, remain on the first covering portion 53A of the molded resin portion 50. The positioning pins are respectively provided above and below the busbar 40 in the Z direction. The positioning pin recesses 63 remain on upward and downward facing surfaces of the first covering portion 53A of the molded resin portion 50 in the Z direction. A plurality of the positioning pin recesses 63 are provided along an extension direction of the first covering portion 53A.

### <Attachment and Detachment of Battery Pack and Busbar Unit>

The attachment and detachment (mounting and removal) of the battery pack 10 and the busbar unit 30 are more specifically described.

In attaching the battery pack 10 and the busbar unit 30, a worker first passes the stud bolt 13A through the bolt fastening portion 41 and passes the fixing bolt 16 through the fixing portion 60 by moving the busbar unit 30 along the Z direction with respect to the battery pack 10 (see FIG. 5). Thereafter, the worker takes a fastening jig such as a wrench and nuts 80 and fasten the nut 80 to each of the stud bolt 13A and the fixing bolt 16 using the fastening jig. At this time, the worker can remove both hands from the busbar unit 30 to take the nuts 80 and the fastening jig.

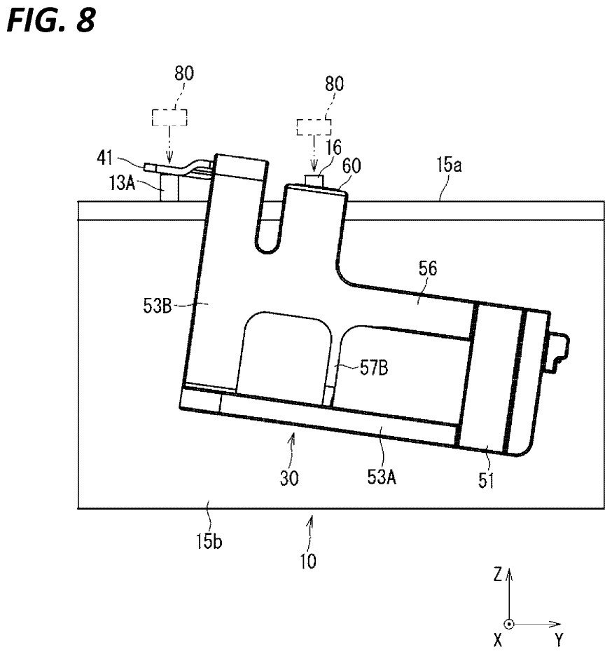

Here, the center of gravity of the busbar unit 30 is located closer to the connector housing portion 51 than the fixing portion 60 along the Y direction. Thus, if rotation is not suppressed by the rotation suppressing portion 57B and the receiving portion 17, the busbar unit 30 may be possibly inclined toward the connector housing portion 51 as shown in FIG. 8 if the worker removes the both hands from the busbar unit 30 before bolting. If the fixing portion 60 is closer to the center of gravity in the Y direction than the bolt fastening portion 41, the busbar unit 30 is inclined to rotate about a contact part of the fixing portion 60 and the fixing bolt 16. If the busbar unit 30 is largely inclined, the bolt fastening portion 41 may come off the stud bolt 13A. Thus, the worker may possibly need to correct the inclination of the busbar unit 30 before the nuts 80 are fastened. Note that FIG. 8 is a diagram showing an inclined state of the busbar unit 30 and an example, in which the battery pack 10 is not provided with the receiving portion 17, is shown in FIG. 8.

In contrast, since rotation is suppressed by the rotation suppressing portion 57B and the receiving portion 17 in the busbar unit 30 of this embodiment, the busbar unit 30 is easily kept in a proper posture as shown in FIG. 5 even if the worker removes the both hands from the busbar unit 30 before bolting. Thus, the worker can directly fasten the nuts 80 without correcting the posture of the busbar unit 30 after taking the nuts 80 and the fastening jig.

Also during the detachment of the busbar unit 30 and the battery pack 10, the busbar unit 30 may be possibly inclined toward the connector housing portion 51 as shown in FIG. 8 if the worker removes the both hands from the busbar unit 30 with the nuts 80 removed when rotation is not suppressed by the rotation suppressing portion 57B and the receiving portion 17. At this time, the fixing portion 60 and the fixing bolt 16 push each other in the Y direction. Thus, if the busbar unit 30 is moved in the Z direction to detach the busbar unit 30 from the battery pack 10, the fixing portion 60 and the fixing bolt 16 may strongly rub against each other.

In contrast, since rotation is suppressed by the rotation suppressing portion 57B and the receiving portion 17 in the busbar unit 30 of this embodiment, the busbar unit 30 is easily kept in the proper posture as shown in FIG. 5 even if the worker removes the both hands from the busbar unit 30 with the nuts 80 removed. Thus, even if the worker directly moves the busbar unit 30 in the Z direction after removing the nuts 80, there is little likelihood that the fixing portion 60 and the fixing bolt 16 strongly rub against each other. Thus, the busbar unit 30 is easily detached from the battery pack 10.

The rotation suppressing portion 57B and the receiving portion 17 may contact each other in a state where the battery pack 10 and the busbar unit 30 are in proper mounting postures. The rotation suppressing portion 57B and the receiving portion 17 may contact each other in a state where the battery pack 10 and the busbar unit 30 are slightly deviated from the proper mounting postures. In this case, the bolt fastening portion 41 is not off the stud bolt 13A, the nut 80 can be attached to the tip of the stud bolt 13A and the inclination of the busbar unit 30 may be corrected to set the busbar 30 in the proper posture by fastening the nut 80.

### <Attachment and Detachment of Busbar Unit and Mating Connector>

The attachment and detachment of the busbar unit 30 and the mating connector 20 are more specifically described.

The busbar unit 30 and the mating connector 20 are attached after the busbar unit 30 is attached to the battery pack 10. The mating connector 20 is moved in a direction (here, direction parallel to the Z direction) of an arrow A1 of FIGS. 1 and 2 along the Z direction with respect to the busbar unit 30, and attached by fitting the tip of the mating connector 20 into the fitting recess 51A.

At this time, a moving direction of the mating connector 20 may be possibly a direction shifted from the arrow A1 in the X direction such as a direction of an arrow A2 or A3 of FIG. 2. In this case, a force for inserting the mating connector 20 into the connector housing portion 51 may possibly act as a force for rotating the connector housing portion 51 about a Y axis. Even in this case, since the projection 55 is supported in contact with the side surface 15b of the battery pack 10 in the busbar unit 30 of this embodiment, even if a force for rotating the connector housing portion 51 about the Y axis is applied to the connector housing portion 51 from the mating connector 20, the rotation of the connector housing portion 51 is suppressed. In this way, the busbar unit 30 and the mating connector 20 are easily attached.

Also during the detachment of the busbar unit 30 and the mating connector 20, a force for pulling out the connector housing portion 51 from the mating connector 20 may be similarly possibly shifted in the X direction. In this case, a force for pulling out the mating connector 20 from the connector housing portion 51 may possibly act as a force for rotating the connector housing portion 51 about the Y axis. Even in this case, since the projection 55 is supported in contact with the side surface 15b of the battery pack 10 in the busbar unit 30 of this embodiment, even if a force for rotating the connector housing portion 51 about the Y axis is applied to the connector housing portion 51 from the mating connector 20, the rotation of the connector housing portion 51 is suppressed. In this way, the busbar unit 30 and the mating connector 20 are easily detached.

The contact of the projection 55 and the side surface 15b of the battery pack 10 functions to suppress the rotation of the busbar unit 30 about the Y axis in an unbolted state during the attachment and detachment of the battery pack 10 and the busbar unit 30. That is, a center of gravity in the X direction is located closer to the connector housing portion 51 than the fixing portion 60 in the busbar unit 30. Thus, if the projection 55 and the side surface 15b of the battery pack 10 are not in contact, the busbar unit 30 may possibly rotate about the Y axis to lower the connector housing portion 51 in the unbolted state. This rotation is suppressed by the contact of the projection 55 and the side surface 15b of the battery pack 10.

### Effects, Etc.

According to the busbar unit 30 configured as described above, since the other end of the busbar 40 is connected to the mating connector 20 in the busbar unit 30, work efficiency relating to the attachment and detachment of the busbar unit 30 and the device is improved as compared to the case where the other end of the busbar 40 is the bolt fastening portion 41 similarly to the one end. Further, by connecting the other end of the busbar 40 to the connector, the other end of the busbar 40 may be possibly not supposed in the state where the bolt fastening portion 41 on the one end of the busbar 40 is not fastened. Even in this case, since the rotation suppressing portion 57B is hooked to the receiving portion 17 of the battery pack 10 to suppress the inclination of the busbar unit 30 toward the connector housing portion 51 in the state where the bolt fastening portion 41 on the one end is not fastened, work efficiency relating to a bolt operation on the one end is improved.

Further, the molded resin portion 50 is made of fiber reinforced plastic. In this case, the fibers flows in the mold together with the resin softened during the molding the molded resin portion. The flow passages for the fiber reinforced plastic during the molding of the molded resin portion 50 are increased and the directions of the fibers contained in the fiber reinforced plastic are scattered by the presence of the first and second coupling portions 56, 57 in the busbar unit 30 even if the molded resin portion 50 is made of fiber reinforced plastic. In this way, it can be suppressed that the molded resin portion 50 is easily cracked in a specific direction.

Further, the molded resin portion 50 includes the cut 61 extending between an end part of the intermediate covering portion 53 on the one end side of the busbar 40 and the fixing portion 60. In this way, stress applied to the busbar unit 30 from the battery pack 10 can be distributed during the expansion of the battery pack 10.

Further, the first coupling portion 56 is thicker than the second coupling portion 57. In this way, a weight increase of the molded resin portion 50 can be suppressed since the second coupling portion 57 is thinner than the first coupling portion 56 while the molded resin portion 50 is firmly reinforced by the first coupling portion 56.

Further, one first coupling portion 56 and one second coupling portion 57 are provided. In this way, a weight increase of the molded resin portion 50 can be suppressed.

Further, the busbar 40 is formed by one plate member from the bolt fastening portion 41 to the connector terminal portion 42. In this way, the busbar 40 including the bolt fastening portion 41 and the connector terminal portion 42 can be provided without welding or the like.

### [Addenda]

Although the molded resin portion 50 has been described thus far to be made of fiber reinforced plastic, this is not essential. For example, the molded resin portion 50 may be, for example, made of resin not containing fibers.

Although the molded resin portion 50 has been described thus far to include the cut 61, this is not essential. The molded resin portion 50 may not include the cut 61 and the fixing portion 60 and the third covering portion 53C may be directly connected.

Further, although the first coupling portion 56 has been described thus far to be thicker than the second coupling portion 57, this is not essential. The first coupling portion 56 may be as thick as the second coupling portion 57 or may be thinner than the second coupling portion 57.

Further, although one first coupling portion 56 and one second coupling portion 57 have been described thus far to be provided, this is not essential. At least either two or more first coupling portions 56 or two or more second coupling portions 57 may be provided.

Further, although the busbar 40 has been described thus far to be formed by one plate member from the bolt fastening portion 41 to the connector terminal portion 42, this is not essential. For example, a plate member including the bolt fastening portion 41 and a plate member including the connector terminal portion 42 may be separately provided and these plate members may be joined by welding or the like.

Although the rotation suppressing portion 57B has been described thus far to be the rib 57B, this is not essential. A rotation suppressing portion may be provided at a position different from the rib 57B. For example, the projection 55 or the rib 58 may function as a rotation suppressing portion. That is, any part of the molded resin portion 50 may suppress the inclination of the busbar unit 30 toward the connector housing portion 51 by contacting the receiving portion 17 of the battery pack 10 in a state where the stud bolt 13A is not fastened after being passed through the bolt fastening portion 41 in a connection module. Also by such a connection module, effects similar to those of the connection module 100 including the above busbar unit 30 and the battery pack 10 can be obtained.

Note that the respective configurations described in the above embodiment and the respective modifications can be appropriately combined as long as these do not contradict each other.

### LIST OF REFERENCE NUMERALS

10 battery pack
11 cell battery
12 battery body
13, 13A terminal (stud bolt)
14 connection conductor
15 enclosure
15a upper surface
15b side surface
16 fixing bolt
17 receiving portion
20 mating connector
21 connector housing
22 lock receiving portion
22a lock piece
22b operating portion
23 connector terminal
24 wire
30 busbar unit
40 busbar
41 bolt fastening portion
42 connector terminal portion
43A, 43B, 43C, 43D bent portion
44 intermediate portion
44A first intermediate portion
44B second intermediate portion
44C third intermediate portion
50 molded resin portion
51 connector housing portion
51A fitting recess
52 lock portion
53 intermediate covering portion
53A first covering portion
53B second covering portion
53C third covering portion
55 projection
56 first coupling portion
57 second coupling portion
57A coupling body
57B rib (rotation suppressing portion)
58 rib
60 fixing portion
61 cut
62 gate mark
63 positioning pin recess
70 collar
80 nut
100 connection module

1. A busbar unit to be electrically connected to a terminal of a battery pack, comprising:
a busbar including a bolt fastening portion provided on one end to be electrically connected to the terminal of the battery pack by being bolted to the terminal and a connector terminal portion provided on the other end to be electrically connected to a connector terminal of a mating connector; and
a molded resin portion for covering the busbar,
the bolt fastening portion and the connector terminal portion of the busbar being provided apart from each other in each of a first direction and a second direction, the first direction being a normal direction to a side surface of the battery pack, the second direction being along the side surface of the battery pack,
the molded resin portion including a connector housing portion for covering the connector terminal portion, an intermediate covering portion for covering an intermediate portion of the busbar extending out from the connector housing portion, a first coupling portion coupling a part of the intermediate covering portion distant from the connector housing portion and the connector housing portion and a second coupling portion coupling a part of the intermediate covering portion closer to the connector housing portion than an intersecting part with the first coupling portion and an intermediate part of the first coupling portion,
a fixing portion to be fixed to the battery pack separately from the bolt fastening portion being provided on a side of the molded resin portion closer to the bolt fastening portion than a center of gravity position of the busbar unit in the second direction, and
the second coupling portion being provided with a rotation suppressing portion to be hooked to a receiving portion of the battery pack to suppress the busbar unit from being inclined toward the connector housing portion in a state where the bolt fastening portion is not fastened.

2. The busbar unit of claim 1, wherein the molded resin portion is made of fiber reinforced plastic.

3. The busbar unit of claim 1, wherein the molded resin portion includes a cut extending between an end part of the intermediate covering portion on the one end side of the busbar and the fixing portion.

4. The busbar unit of claim 1, wherein the first coupling portion is thicker than the second coupling portion.

5. The busbar unit of claim 1, wherein one first coupling portion and one second coupling portion are provided.

6. The busbar unit of claim 1, wherein the busbar is formed by one plate member from the bolt fastening portion to the connector terminal portion.

7. A connection module, comprising:
a battery pack including a terminal;
a mating connector including a connector terminal and a connector housing; and
a busbar unit including a busbar for connecting the terminal and the connector terminal and a molded resin portion for covering the busbar,
the busbar including a bolt fastening portion provided on one end to be fastened to the terminal by a bolt and a connector terminal portion provided on the other end to be connected to the connector terminal,
the molded resin portion including a connector housing portion to be fit to the connector housing while covering the connector terminal portion, and an intermediate covering portion for covering an intermediate portion of the busbar extending out from the connector housing,
a center of gravity of the busbar unit being closer to the connector housing portion than the bolt fastening portion, and
a receiving portion of the battery pack and the molded resin portion contacting to suppress the busbar unit from being inclined toward the connector housing portion in a state where the bolt is not fastened after being passed through the bolt fastening portion.
